(19) United States
(12) Patent Application Publication
(10) Pub. No.: US 2018/0221815 A1
(43) Pub. Date: Aug. 9, 2018

(54) METHOD AND SYSTEM FOR CARBON DIOXIDE GAS DEHYDRATION

(71) Applicant: CHIYODA CORPORATION, Yokohama-shi, Kanagawa (JP)

(72) Inventors: Yoshitsugi KIKKAWA, Yokohama-shi, Kanagawa (JP); Etsuro SATO, Yokohama-shi, Kanagawa (JP); Takeshi HINO, Yokohama-shi, Kanagawa (JP); Shinji KANETA, Yokohama-shi, Kanagawa (JP); Junichiro TANAKA, Yokohama-shi, Kanagawa (JP)

(21) Appl. No.: 15/748,411

(22) PCT Filed: Jul. 30, 2015
(86) PCT No.: PCT/JP2015/003850

§ 371 Date: Jan. 29, 2018

(51) Int. Cl. B01D 53/26; B01D 53/02; C01B 32/50

(52) U.S. Cl. CPC B01D 53/265; B01D 53/261; B01D 53/263; B01D 53/02; B01D 2257/80; B01D 2252/2023; B01D 2253/104; B01D 2253/108; B01D 2256/22; C01B 32/50

(57) ABSTRACT

In a system for dehydrating carbon dioxide gas, the carbon dioxide gas is cooled by using a turbo expander (21), and the power extracted by the turbo expander from the carbon dioxide gas is used in the system for compressing the carbon dioxide gas. The cooled carbon dioxide gas is fed to a knock-out drum (22) to remove free water therefrom. The carbon dioxide gas from the separator is introduced to a secondary dehydration unit (11) and recompressed to the required pressure for carbon storage or for EOR operation.

### TECHNICAL FIELD

The present invention relates to a method and system for dehydrating carbon dioxide gas in an energy efficient manner.

### BACKGROUND ART

Carbon dioxide gas is a primary greenhouse gas emitted through human activities, and the increased emission of carbon dioxide into the atmosphere due to the worldwide industrialization is believed to be a major cause of the global warming. Because fossil fuels will continue to be a major source of energy that is required to maintain civilized lifestyles for a long time in future, proposals have been made to capture the carbon dioxide which is otherwise emitted to the atmosphere, by using a chemical process such as the amine process, and to deposit the captured dioxide in storage sites typically created in deep underground formations. Such a process is commonly known as the carbon capture and storage (CCS) process.

If the water content of the captured carbon dioxide gas is high, free water combined with carbon dioxide is highly acidic, and this may cause the various vessels, pipes and machinery that are used to process and transport the carbon dioxide to corrode quickly because they are mostly made of carbon steel. In particular, such storage sites are typically situated far away from the generation sites of carbon dioxide so that the captured carbon dioxide is required to be transported by using pipelines and stored in tanks. As other corrosion resistant materials are too costly to be used for such facilities, it is imperative to reduce the water content of the captured carbon dioxide.

In particular, in regions where the ambient temperature is relatively low, because water condensation occurs more actively than in warmer regions, the required level of dehydration is more stringent. Conventionally, a refrigeration unit was required to dehydrate carbon dioxide gas to a high level of dryness, and this increased the initial and operating costs of the carbon dioxide dehydration system.

Detailed discussion on the dehydration of carbon dioxide can be found in the following prior art references.
Reference 1: Michal Netusil and Pavel Ditl, “Natural Gas Dehydration”, Chapter 1, INTECH, 2012, available at http://dx.doi.org/10.5772/45802
Reference 2: Luuk Buit, Mohammad Ahmad, Wim Mallon and Fred Hage, “CO2 EuroPipe study of the occurrence of free water in dense phase CO₂ transport”, Energy Procedia, Volume 4, 2011, Pages 3056-3062, available at http://www.sciencedirect.com/science/article/pii/S1876610211004140

### SUMMARY OF INVENTION

In view of such problems of the prior art, a primary object of the present invention is to provide a system for dehydrating carbon dioxide gas both economically and in an energy efficient manner.

To achieve such objects, the present invention provides a carbon dioxide gas dehydration system, comprising: at least one stage of preliminary dehydration unit including a compressor, a cooler and a knock-out drum; and a primary dehydration unit including a turbo expander having an inlet connected to the preliminary dehydration unit and a knock-out drum connected to an outlet of the turbo expander. The knock-out drum as used herein may include any other form of vessel that can be used for separating liquid from gas.

Thereby, the carbon dioxide gas can be dehydrated to a highly dry condition without requiring costly equipment, and in a highly energy efficient manner. Typically, a pressure at the outlet of the turbo expander is in the range of 2 MPa to 7 MPa, and the temperature at the outlet of the turbo expander is in the range of 0 degrees Celsius to 30 degrees Celsius.

The power produced by the turbo expander may be used for powering an electric generator or any of the compressors used in the carbon dioxide gas dehydration system.

If an even higher level of dehydration is required, a secondary dehydration unit may be connected to an outlet of the primary dehydration unit. Such a second dehydration unit may consist of a desiccant dehydration unit or a glycol (TEG) dehydration unit.

The present invention further provides a carbon dioxide gas dehydration method, comprising: compressing wet carbon dioxide gas by using a compressor; cooling the compressed wet carbon dioxide gas; separating water from the cooled carbon dioxide gas; expanding the partially dehydrated carbon dioxide gas by using a turbo expander; and separating water from the expanded carbon dioxide gas.

### BRIEF DESCRIPTION OF DRAWINGS

FIG. 1 is a diagram showing a carbon dioxide gas dehydration system embodying the present invention;

FIG. 2 is a diagram showing the secondary dehydration unit used in the carbon dioxide gas dehydration system in a greater detail; and

FIG. 3 is a diagram showing an alternate embodiment of the secondary dehydration unit.

### DESCRIPTION OF EMBODIMENTS

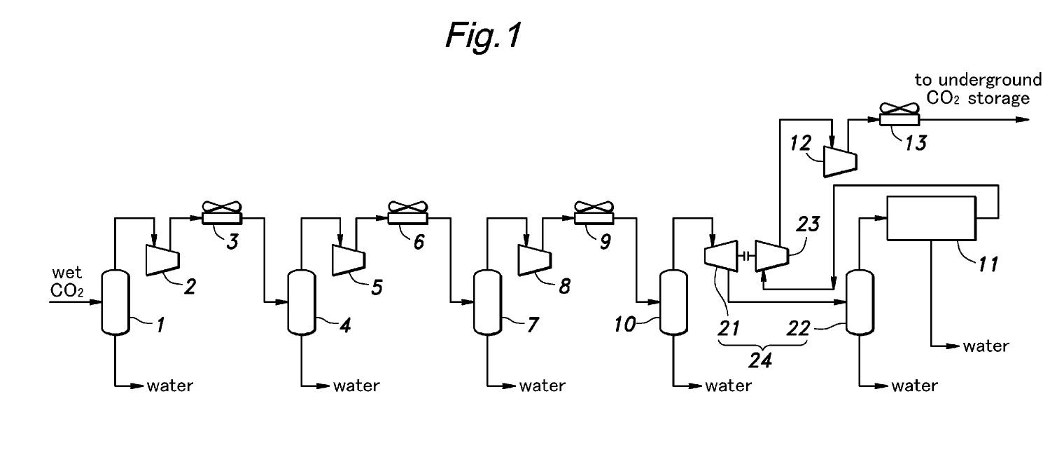

In the carbon dioxide gas dehydration system illustrated in FIG. 1, carbon dioxide captured by an acid gas removal unit based on the amine scrubbing process provided in a chemical plant such as an LNG plant and a petrochemical plant is introduced into a vapor-liquid separator commonly known as a knock-out drum 1 at 45 degrees Celsius and 178 KPa to separate the entrained water therefrom. The carbon dioxide gas exiting from the knock-out drum 1 is then compressed by a compressor 2 to 650 kPa and 175 degrees Celsius. The hot carbon dioxide gas is introduced into a cooler 3, which cools the carbon dioxide gas down to 45 degrees Celsius. The cooled carbon dioxide from the cooler 3 is introduced into a knock-out drum 4, which separates the condensed water therefrom.

The carbon dioxide gas from the knock-out drum 4 is then compressed by a compressor 5 to 2,100 kPa and 171 degrees Celsius. The hot carbon dioxide gas is introduced into a cooler 6, which cools the carbon dioxide gas down to 45 degrees Celsius. Then the carbon dioxide from the cooler 6 is introduced into a knock-out drum 7, which separates the condensed water therefrom.

The carbon dioxide gas from the knock-out drum 7 is then compressed by a compressor 8 to 7,000 kPa and 171 degrees Celsius. The hot carbon dioxide gas is introduced into a cooler 9, which cools the carbon dioxide gas down to 45 degrees Celsius. Then the carbon dioxide from the cooler 9 is introduced into a knock-out drum 10, which separates the condensed water therefrom.

As discussed above, three stages of water separation each containing a compressor, a cooler and a knock-out drum have been applied to the captured carbon dioxide, but this process becomes less efficient as the number of stages is increased although a further dehydration is required for a favorable handling of the carbon dioxide. At the downstream end of the last knock-out drum 10, the water content is about 1,900 ppm, and the temperature and pressure are 45 degrees Celsius and 6,947 kPa, respectively. This pressure is somewhat higher than the typical pressure of about 5,000 kPa at the inlet end of the dehydration unit of the conventional carbon dioxide dehydration system which typically uses a refrigeration unit for further dehydration.

Therefore, according to the illustrated embodiment of the present invention, a primary dehydration unit 24 is provided downstream of the last knock-out drum 10. The primary dehydration unit 24 includes a turbo expander 21 that reduces the temperature and pressure of the carbon dioxide to 20 degrees Celsius and 5,000 kPa, respectively. The pressure at this point may range between 150 kPa and 20 MPa for the normal temperature range of 0 to 45 degrees Celsius. However, when the temperature is below 15 degrees Celsius, hydrate formation may occur. The solubility of water in carbon dioxide drops sharply around 5,000 kPa at 10 to 20 degrees Celsius, for instance. See FIG. 1 of Reference 2. Therefore, the temperature and pressure of the carbon dioxide at the outlet end of the turbo expander 21 may be in the ranges of 2 MPa to 7 MPa and 0 degrees Celsius to 30 degrees Celsius, respectively, and more preferably, in the ranges of 3,000 kPa to 6,500 kPa and 15 degrees Celsius to 25 degrees Celsius, respectively.

The power that is produced by the turbo expander 21 may be used for powering an electric generator, or may be used for compressing the carbon dioxide in any part of the system. The primary dehydration unit 24 further comprises a knock-out drum 22 connected to the downstream end of the turbo expander 21. The water content at the outlet of the knock-out drum 22 is reduced to about 500 ppm as a result.

As discussed earlier, the carbon dioxide is required to be dehydrated in order to avoid acidic corrosion by water condensation (because the piping, vessels and valves are normally made of carbon steel) and to avoid hydrate formation at the downstream end. The dew point in a carbon dioxide environment varies depending on the temperature and pressure. Typically, the higher the temperature is and the higher the pressure is, the higher the dew point becomes. For instance, when the pipeline route for carbon dioxide passes an arctic region, the ambient temperature will drop to less than −60 degrees Celsius, and the water content in the carbon dioxide gas needs to be less than 20 ppm mol in order to avoid water condensation and the resulting corrosion issue. When the pipeline route passes a northern part of the north America, the ambient temperature may drop to about −20 degrees Celsius, and the water content in the carbon dioxide gas needs to be less than 80 ppm mol.

Therefore, in such a case, the carbon dioxide is required to be further dehydrated by using a secondary dehydration unit 11 which may consist of a vessel filled with solid desiccants or a glycol dehydration unit.

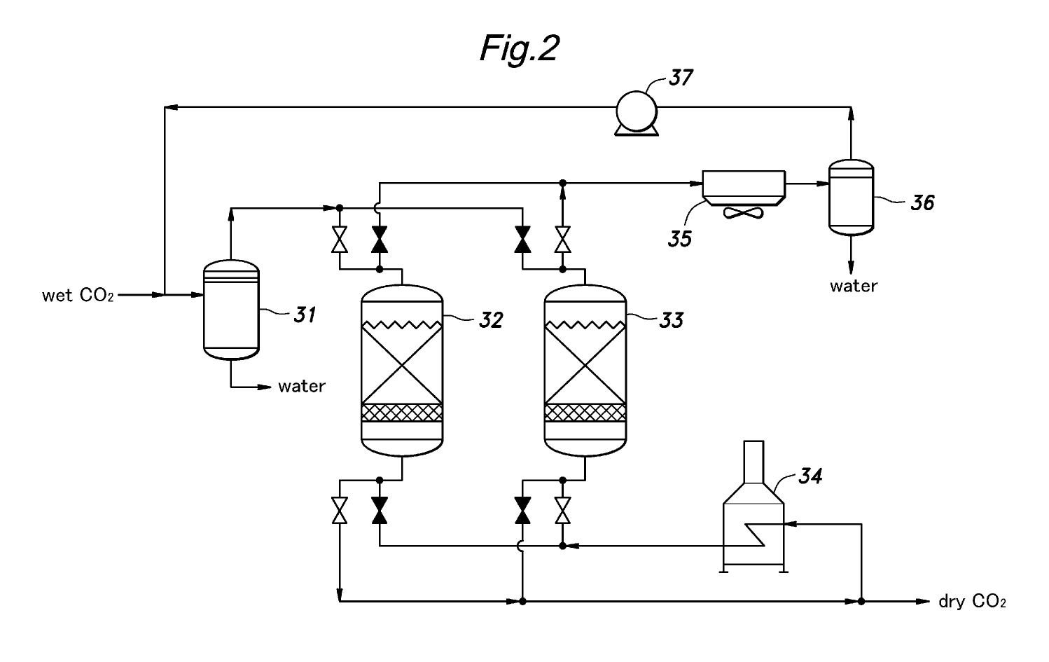

FIG. 2 shows a secondary dehydration unit 11 consisting of a solid desiccants type dehydration unit which includes two or more towers filled with a desiccant and associated regeneration equipment. There are a number of known solid desiccants which possess the physical characteristic to adsorb water from carbon dioxide and other gases. The illustrated embodiment consists of a simple two-tower system. One of the towers (on-stream tower) 32 is connected to the carbon dioxide stream to adsorb water from the carbon dioxide while the other tower (off-stream tower) 33 is being regenerated and cooled at any particular time point.

The carbon dioxide gas expelled from the primary dehydration unit 24 is introduced into the on-stream tower 32 via an inlet separator 31. The carbon dioxide gas is dehydrated by the desiccant in the on-stream tower 32, and expelled therefrom as dry carbon dioxide gas. Hot gas obtained by heating a part of the carbon dioxide gas expelled from the on-stream tower 32 by using a generation gas heater 34 is used to drive off the adsorbed water from the desiccant in the off-stream tower 33. After the adsorbed water has been adequately driven off, the unheated carbon dioxide gas that can be obtained from the on-stream tower 32 is then used for cooling the off-stream tower 33. The gas used for driving off water from the desiccant and cooling the off-stream tower is cooled by a generation gas cooler 35 and after being removed of moisture therefrom in a knock-out drum 36, is recycled to the inflow of the secondary dehydration unit 11 via a pump 37. The towers 32 and 33 are switched before the on-stream tower becomes water saturated.

Desiccants for common industrial use fall into one of three categories; gels (alumina or silica gels manufactured and conditioned to have an affinity for water), alumina (manufactured or natural occurring form of aluminum oxide that is activated by heating) and molecular sieves (manufactured or naturally occurring alumino-silicates exhibiting a degree of selectivity based on the crystalline structure in their adsorption of natural gas constituents). Any of such desiccants may be used in the towers 32 and 33 of the illustrated embodiment.

Referring to FIG. 1 once again, the dry carbon dioxide expelled from the secondary dehydration unit 11 is compressed by a compressor 23 which is powered by the turbo expander 21 in the illustrated embodiment. The compressed carbon dioxide is optionally further compressed by a second compressor 12 to a pressure suitable for the final storage, and is cooled by a cooler 13. Then, the carbon dioxide gas expelled from the cooler 13 may be pumped into an underground carbon dioxide storage site. At this point, the temperature and pressure of the carbon dioxide gas are 45 degrees Celsius and 15,000 kPa, respectively.

The compressed carbon dioxide may also be used for EOR (enhanced oil recovery) operation, and other industrial applications.

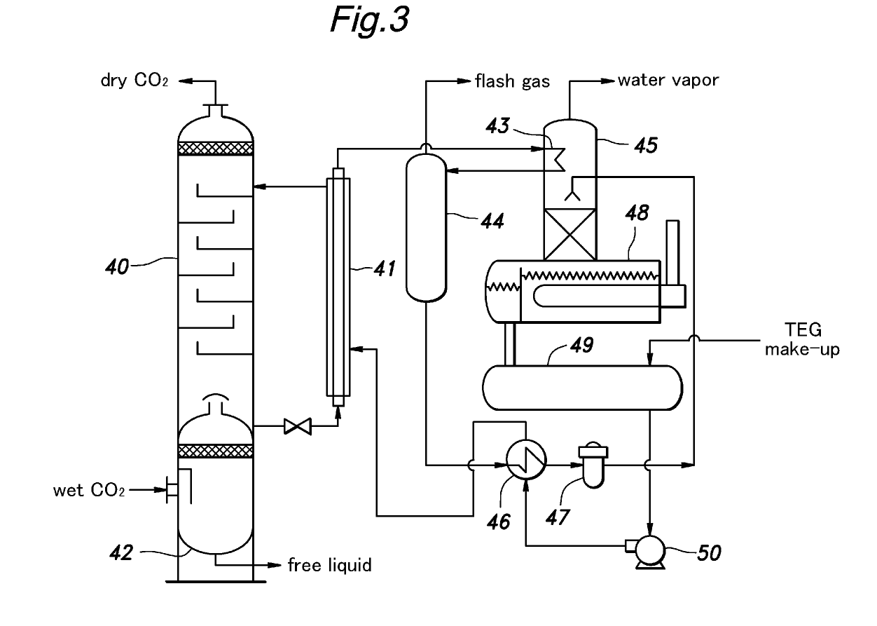

FIG. 3 shows an alternate embodiment of the secondary dehydration unit 11 consisting of a TEG (triethylene glycol) dehydration unit. A contactor (absorber) 40 consisting of a vertically elongated vessel is used. The wet carbon dioxide is introduced from an inlet scrubber 42 formed in a lower end of the contactor 40.

Regenerated glycol (as will be described hereinafter) is pumped (by using a pump 50) into the contactor 40 from an upper end thereof via a rich-lean heat exchanger 46 and a glycol heat exchanger 41, and as it flows down through the contactor 40 countercurrent to the gas flow, absorbs water. The wet carbon dioxide gas contacts the downward flow of glycol as it travels upward in the contactor 40. The dehydrated carbon dioxide gas is then expelled from the top end of the contactor 40.

The water-rich glycol exiting from the lower end of the contactor 40 passes through the glycol heat exchanger 41 to exchange heat with the glycol that is introduced into the contactor 40 from the top end thereof, and then into a reflux condenser coil 43 provided in a still forming a main part of a regenerator 45 (which will be described hereinafter). By using heat from a reboiler 48 (which will be described hereinafter) for heating the still, most of the carbon dioxide gas dissolved in the water-rich glycol is flashed off in a flash tank 44 connected to the downstream end of the reflux condenser coil 43. The glycol expelled from the flash tank 44 (water-rich glycol) is passed through the rich-lean heat exchanger 46 and a filter 47, and is forwarded to the regenerator 45. The rich-lean heat exchanger 46 exchanges heat between the regenerated glycol (water-lean glycol) and the water-rich glycol.

In the regenerator 45, the absorbed water is distilled from the glycol at near atmospheric pressure by application of a heat from the reboiler 48, and the glycol is caused to condense on the reflux condenser coil 43. The regenerated (water-lean) glycol is collected in a surge drum 49, and is passed through the rich-lean heat exchanger 46 to be recirculated back to the contactor 40.

The prior art references mentioned in this application are hereby incorporated into the present application by reference. Although the present invention has been described in terms of preferred embodiments thereof, it is obvious to a person skilled in the art that various alterations and modifications are possible without departing from the scope of the present invention which is set forth in the appended claims.

1. A carbon dioxide gas dehydration system, comprising:
at least one stage of preliminary dehydration unit including a compressor, a cooler and a knock-out drum; and
a primary dehydration unit including a turbo expander having an inlet connected to the preliminary dehydration unit and a knock-out drum connected to an outlet of the turbo expander.

2. The carbon dioxide gas dehydration system according to claim 1, wherein a pressure at the outlet of the turbo expander is in the range of 2 MPa to 7 MPa.

3. The carbon dioxide gas dehydration system according to claim 1, wherein a temperature at the outlet of the turbo expander is in the range of 0 degrees Celsius to 30 degrees Celsius.

4. The carbon dioxide gas dehydration system according to claim 1, wherein the turbo expander is used for powering a compressor for carbon dioxide.

5. The carbon dioxide gas dehydration system according to claim 1, wherein the turbo expander is used for powering an electric generator.

6. The carbon dioxide gas dehydration system according to claim 1, further comprising a secondary dehydration unit connected to an outlet of the primary dehydration unit.

7. The carbon dioxide gas dehydration system according to claim 6, wherein the secondary dehydration unit consists of a desiccant dehydration unit.

8. The carbon dioxide gas dehydration system according to claim 6, wherein secondary dehydration unit consists of a glycol (TEG) dehydration unit.

9. A carbon dioxide gas dehydration method, comprising:
compressing wet carbon dioxide gas by using a compressor;
cooling the compressed wet carbon dioxide gas;
separating water from the cooled carbon dioxide gas;
expanding the partially dehydrated carbon dioxide gas by using a turbo expander; and
separating water from the expanded carbon dioxide gas.
